(19) United States
(12) Patent Application Publication
(10) Pub. No.: US 2014/0205734 A1
(43) Pub. Date: Jul. 24, 2014

(54) METHOD FOR CREATION AND DISTRIBUTION OF A TEA FLAVORED ALCOHOLIC BEVERAGE

(71) Applicant: Nathaniel Lawrence, New Orleans, LA (US)

(72) Inventor: Nathaniel Lawrence, New Orleans, LA (US)

(21) Appl. No.: 14/162,662

(22) Filed: Jan. 23, 2014

Related U.S. Application Data
(60) Provisional application No. 61/756,119, filed on Jan. 24, 2013.

(51) Int. Cl. A23F 3/16; C12G 1/06

(52) U.S. Cl. CPC A23F 3/16; C12G 1/06
USPC 426/592

(57) ABSTRACT

The invention is a refreshing drink that is tea flavored and also has alcohol in it. It comprises a tea extract, lemon juice, citric acid, and sec champagne combination that are within well defined concentration thresholds for the creation of the beverage. Further it is contemplated that a unique method of preparation is fun for the consumers and creators of the beverage which will enhance the social aspects of its consumption.

### CROSS-REFERENCE TO RELATED APPLICATIONS

This application claims priority to U.S. provisional application 61/756119

### STATEMENT REGARDING FEDERALLY FUNDED RESEARCH

Not Applicable

### REFERENCE TO A MICROFICHE APPENDIX

Not applicable

### BACKGROUND OF THE INVENTION

1. Field of the Invention/Technical Field

The present invention is in the technical field of beverages, recipes and food distribution.

2. Description of Related Art/Background Art

There are numerous tea flavored alcoholic drinks, however the alcohol substrate that is added to the base varies depending on the liqueur that is used to create it. For example, there is firefly vodka, a 40 proof sweet tea flavored vodka, Absolut Wild Tea which uses oolong tea and elderflower flavoring and Jeremiah Weed Sweet Tea Vodka. In addition, there is the Gunfire drink which is a British cocktail made of black tea and rum and also there is Artillery punch which has string black tea, whiskey wine and rum.

There are also champagne and tea combinations. One of these is Champagne Tea, a non-alcoholic summertime mix. Another is sold by the company Teavana, which sells an oolong tea and herbal blend accompanied with Sparkling Strawberry Rose Champagne. Yet another is a green tea champagne which combines 2 tablespoons green tea leaves and 1 750 milliliter bottle of brut Champagne. However, non of these drinks is mixed with the specified combination of ingredients herein.

### GENERAL SUMMARY OF THE INVENTION

While people generally enjoy both the tea flavor and the consumption of alcohol, they also prefer to have a drink at lower alcohol concentrations than the prior art for social functions. Champagne is generally 15-20% alcohol, a higher concentration of alcohol than most wines, therefore champagne consumption is likely needed to have extensive monitoring when consumed for pleasure. At social gatherings champagne is considered a luxury or celebratory and therefore its use is often limited.

In contrast, iced tea is avidly consumed by many people in many different situations. It is often associated with enjoyment of beverages on a hot day in southern parts of the United States. Thus, the taste of tea combined with champagne is likely a desired combination. This invention is a unique blend of ingredients specifically made so that an individual may enjoy the perfect blend of iced tea and champagne so that one can enjoy a refreshing drink. It comprises a tea extract, lemon juice, citric acid, and sweet champagne combination that are within well defined concentration thresholds for the creation of the beverage. Further it is contemplated that a unique method of preparation is fun for the consumers and creators of the beverage which will be of value to the marketing of the invention and therefore is disclosed herein.

### BRIEF DESCRIPTION OF THE DRAWINGS

FIG. 1 is a diagrammed series of steps view that shows and over all method for creating and distributing the tea flavored alcohol beverage.

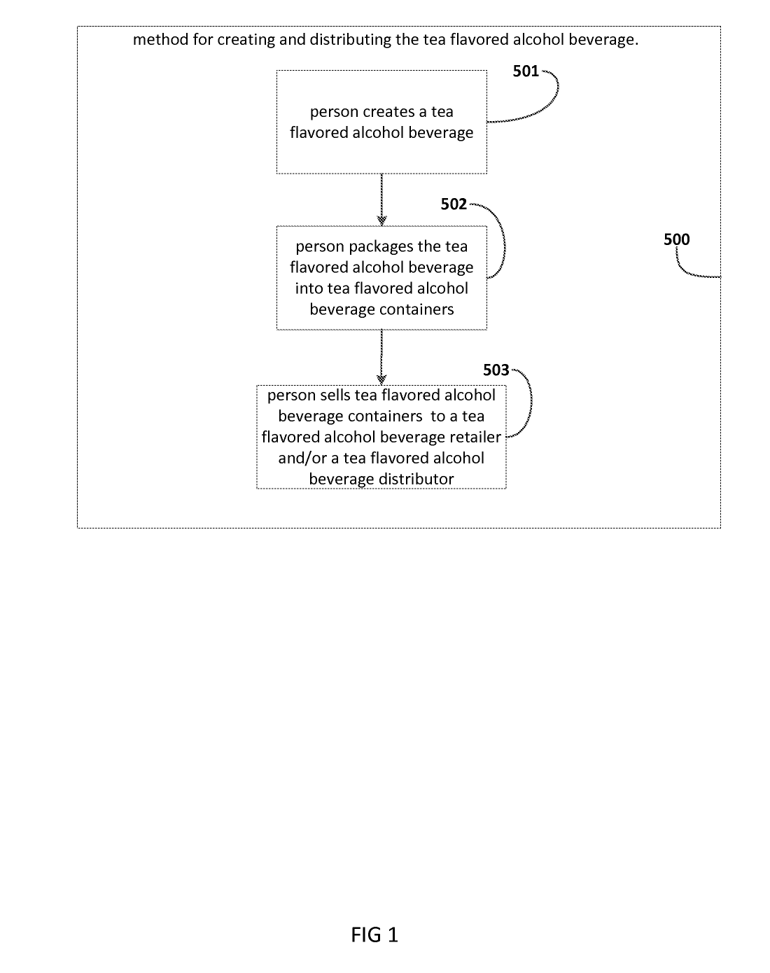

FIG. 2 is a diagrammed series of steps view that shows the overall steps for creating the tea flavored alcohol beverage.

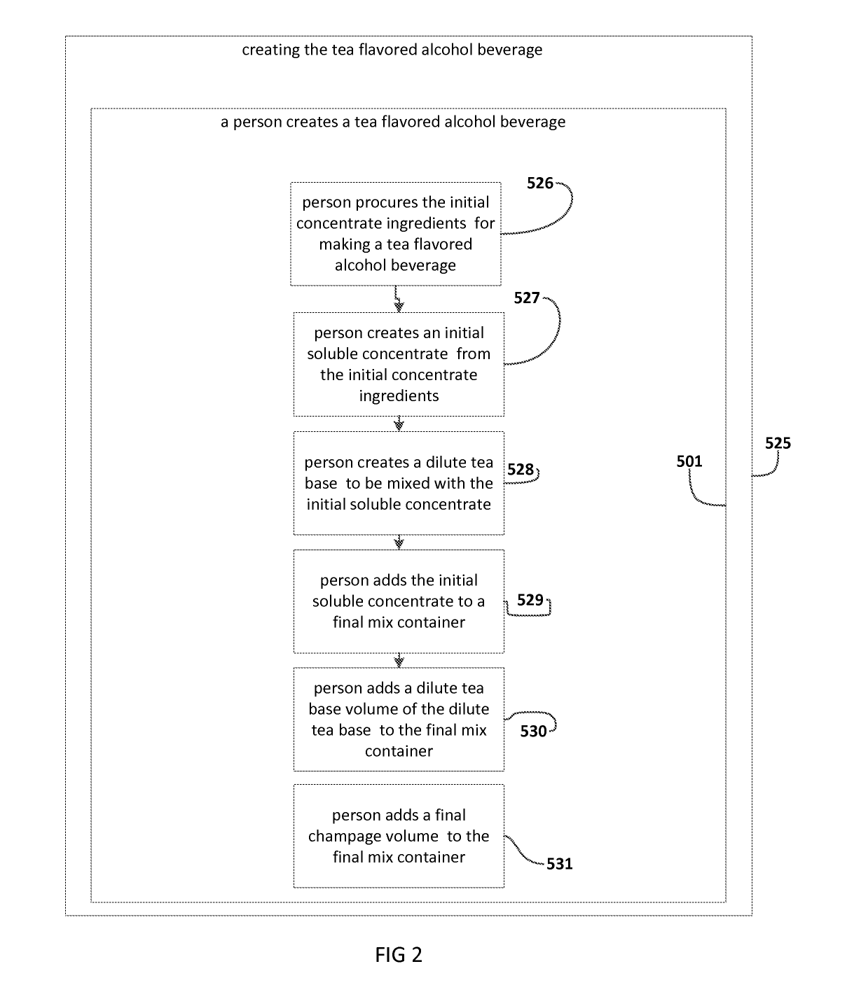

FIG. 3 is a diagrammed series of steps view that shows the overall steps for procuring the ingredients for the tea flavored alcohol beverage.

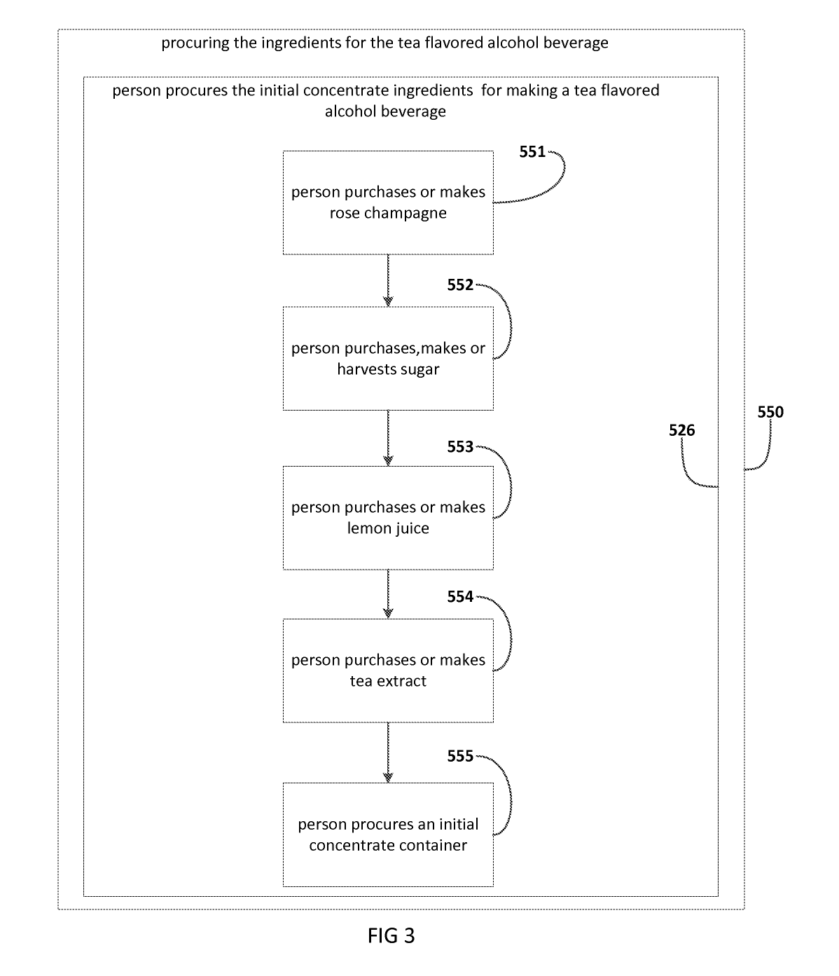

FIG. 4 is a diagrammed series of steps view that shows the overall steps for creating the initial soluble concentrate from the initial concentrate ingredients.

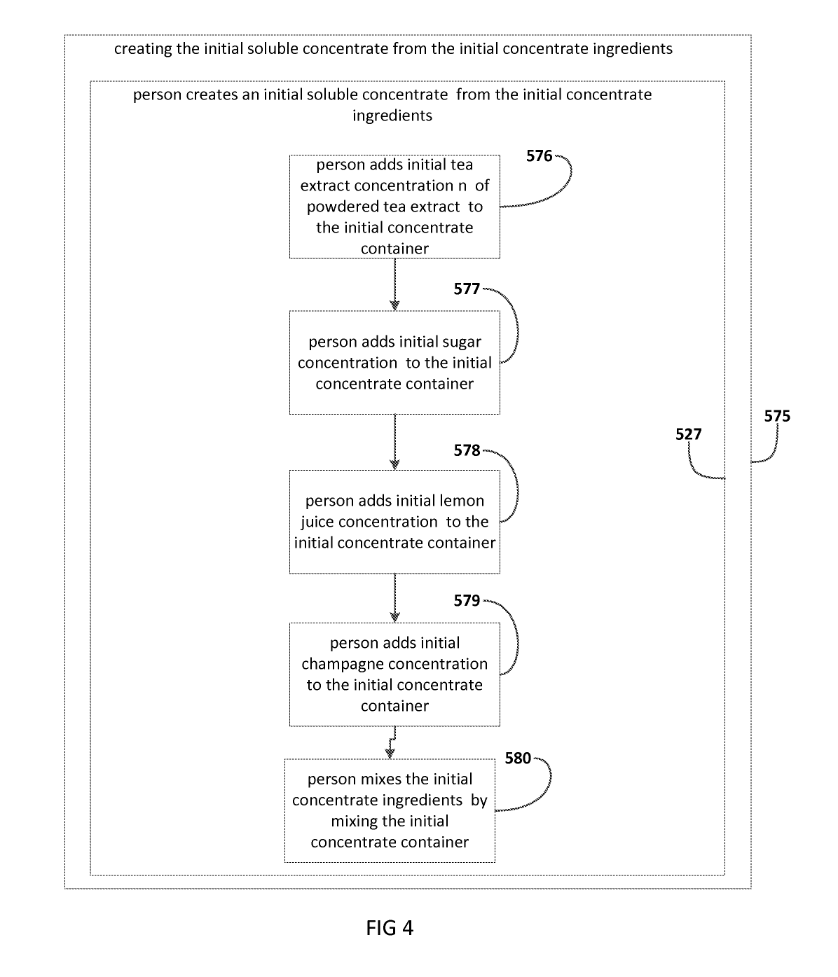

FIG. 5 is a diagrammed series of steps view that shows the overall steps for creating the dilute tea base.

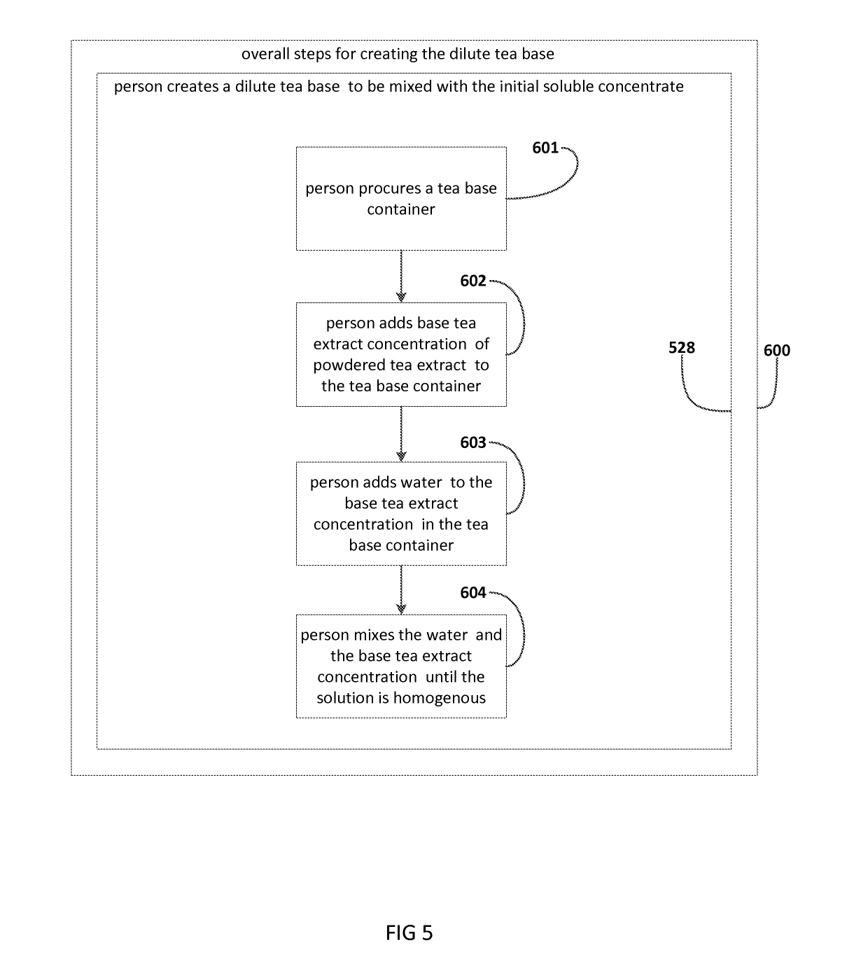

### DETAILED DESCRIPTION OF THE INVENTION

The invention has several sub steps for using it which are as follows: a person creates a tea flavored alcohol beverage 1 (herein termed the Method (1)-Step(1) 501. The term tea flavored alcohol beverage 1 is thought to encompass a beverage comprised of tea extract 22 and rose champagne 3 that forms the basis of this invention.

Next, a person packages the tea flavored alcohol beverage 1 into tea flavored alcohol beverage containers 39, (herein termed the Method (1)-Step(2) 502). The term tea flavored alcohol beverage containers 39 may include an item used to contain, store, and/or transport the tea flavored alcohol beverage 1. Example types of containers may include bottles, gallon jugs, aluminum cans, glass containers, plastic containers, high density polyethylene containers, polyethylene terephthalate (PET) clear plastic containers, tetra brik containers, gable top containers, bi-metal containers or box-like containers.

Finally, a person sells tea flavored alcohol beverage containers 39 to a tea flavored alcohol beverage retailer 52 and/or a tea flavored alcohol beverage distributor 51, (herein termed the Method (1)-Step(3) 503). The Step 503 employs both the tea flavored alcohol beverage distributor 51 and the tea flavored alcohol beverage retailer 52 for performing the step. The term tea flavored alcohol beverage distributor 51 is thought to encompass a business that may act to provide transportation, refrigerated or non-refrigerated storage and/or maintenance for tea flavored alcohol beverage 1, and may sell the tea flavored alcohol beverage 1 to a tea flavored alcohol beverage retailer 52.

When using the invention, one may reason that the tea flavored alcohol beverage retailer 52 in some embodiments may be a grocery store 53, a convenience store 54, a liquor store 55, a grocery store that sells liquor 56, a restaurants 57, a taverns 58, a bars 59, or a temporary event retailers 60. The term tea flavored alcohol beverage retailer 52 is broadly thought to include a person or business that sells alcohol beverages to individual retail customers, from a particular place (premises). The aforementioned method is herein termed Method (1) 500.

In addition, the Step 501 has several sub steps which are as follows: first, a person procures the initial concentrate ingredients 2 (the ingredients that are used to create the tea flavored alcohol beverage) for making a tea flavored alcohol beverage 1 (herein termed the Method (2)-Step(1) 526.

Then, a person creates an initial soluble concentrate 26 (a concentrated premixture of ingredients) from the initial concentrate ingredients 2, (herein termed the Method (2)-Step(2) 527). If the total volume of the final mixture is 1 us gallon-3785 ml than it is expected that the initial soluble concentrate volume will be approximately 1 cup-237 ml (˜5-7% of the total final volume). The term initial concentrate ingredients 2 is thought to encompass the ingredients that are used to create the tea flavored alcohol beverage 1. One purpose of Step 527 is to 1) create a concentrated mixture of soluble ingredients that will rapidly blend with the dilute tea base 32 and another is to 2) have the initial concentrate ingredients 2 be dissolved in an alcohol-based solute so as to ameliorate the dissolution of the citric acid 19 of the lemon juice 18 and tea extract 22 solubility and speed up the process of having a homogenous tea flavored alcohol beverage 1.

Next, a person creates a dilute tea base 32 to be mixed with the initial soluble concentrate 26, (herein termed the Method (2)-Step(3) 528). The term dilute tea base 32 is broadly thought to include a mixture of tea extract 22 and water 35 that is mixed with the initial soluble concentrate 26. It is thought that the dilute tea base is a mixture of normal strength tea created from tea extract and water. For example, for 1 gallon final volume, anywhere from 100-350 ml of tea extract (depending on black powder, manga, or commercial iced tea mix) may be used with the rest of the gallon being filled with water. Then, a person adds the initial soluble concentrate 26 5-7% of the final mix container 36, (a nominal storage or mixing unit, prior to distribution) herein termed the Method (2)-Step(4) 529).

Then, a person adds a dilute tea base volume 37, which may be 45-43% % of the final mixture of the dilute tea base 32 to the final mix container 36, (herein termed the Method (2)-Step(5) 530). The term dilute tea base volume 37 is thought to encompass the volume of dilute tea base 32 that is mixed with the initial soluble concentrate 26 in order to create the tea flavored alcohol beverage 1. One purpose of the dilute tea base volume 37 when added to the final mixture is that it dilutes the concentration of champagne and alcohol. This is seen as a necessity in order to make it light and refreshing. Further, it is contemplated that it serves to decrease the acid reflux that may be accompany the social drinking of champagne by itself. When the champagne concentration is diluted however it will leave the drink feeling flat. This problem is solved by adding citric acid to the mix (which may be in the form of lemon juice). This restores both the bite and feeling of carbonation for the consumer such that any dilution can be compensated. Finally, a person adds a final champagne volume 38, 50% of the final volume, to the final mix container 36, (herein termed the Method (2)-Step(6) 531).The aforementioned method is herein termed Method (2) 525.

In more detail, the Step 526 has several sub steps for using it which are as follows: First, the person purchases or makes rose champagne 3 (herein termed the Method (3)-Step(1) 551. For this invention, the term rose champagne 3 is thought to encompass a sweet sparkling wine which has had a secondary fermentation of the wine in the bottle to create carbonation, or may have alternative means for induction of carbonation. Experiments done by the inventor have shown that iced tea combined with brut dry champagne were not palatable due to the inherent taste of the non-sec champagne. Therefore, it is contemplated that in preferred embodiments that only sweet (demi-sec, sec) champagne would be preferred over dry (extra-brut, brut), though it is possible that addition of sugar to the tea flavored alcohol beverage 1 may allow dry champagne to be used. In other embodiments, types of champagne may include demi-sec rose champagne or sec rose champagne.

Then, the person purchases, makes or harvests sugar 10, (herein termed the Method (3)-Step(2) 552). For the purposes of this invention, the term sugar 10 is thought to encompass chemically-related sweet-flavored substances present as monosaccharides or disaccharides. In addition artificial sweeteners such as aspartame, artificial sweetener, aspartame, stevia, sucralose, neotame, acesulfame potassium or saccharin are thought to be substitutes that may function to mimic some of the properties of the invention.

Next, The person purchases or makes lemon juice 18, (herein termed the Method (3)-Step(3) 553). In some embodiments, not just the preferred, the term lemon juice 18 may include juice from the yellow fruit from the citrus limon species of tree native to Asia. The lemon juice is used for the citric acid, which helps to restore the bite and feeling of carbonation after tea dilution. However, comparable substitutes for lemon flavor may be lemon myrtle, or lemongrass flavor as long as separately, citric acid may be added. It is well known that citric acid is a 5%-6% part of lemon juice. Further it the citric acid acts as a preservative for the beverage allowing a longer shelf life. The term citric acid 19 is thought to encompass weak organic acid which is used to add a sour or tart taste to foods and/or drinks.

Next, the person purchases or makes tea extract 22, (herein termed the Method (3)-Step(4) 554). The term tea extract 22 is thought to encompass purified extract or compositions containing purified extracts from the leaves of the tea plant, which are purified from the Camellia sinensis plant. Alternatively, the tea extract 22 may be an tea powder 23 or also an iced tea mix 24 in some embodiments of the invention. Last, The person procures an initial concentrate container 31, broadly thought to include container capable of holding and mixing the initial concentrate ingredients 2. (herein termed the Method (3)-Step(5) 555). The aforementioned method is herein termed Method (3) 550.

The Step 527 has several sub steps for using it which are as follows: a person adds initial tea extract concentration 27 of powdered tea extract 22 to the initial concentrate container 31 (herein termed the Method (4)-Step(1) 576. In the preferred embodiment, the initial tea extract concentration 27 volume is approximately ¼ cup (˜60 ml), but in other instances the initial tea extract concentration 27 volume may also from a least volume of 3/16 cup to a highest volume of 5/16 cup. In another embodiment of the invention it is possible that a Person adds ¼ cup of powdered iced tea mix to the initial concentrate container 31, herein termed as method (4)-step(6) 581, instead of Step 576.

Then, a person adds initial sugar concentration 28 to the initial concentrate container 31, (herein termed the Method (4)-Step(2) 577). The initial sugar concentration 28 should have a volume of ½ cup (or ˜120 ml), but in some cases it is thought that the volume may from a minimum value of 7/16 cup to a largest value of 9/16 cup. Functionally, Step 577 could also be either one where a person adds concentrated soluble sugar to the initial concentrate container 31 equivalent to a ½ cup of sugar, herein termed as method (4)-step(6) 581, or alternatively be one where a person adds concentrated artificial sweetener to the initial concentrate container 31 equivalent to a ½ cup of sugar in sweetness, herein termed as method (4)-step(7) 582.

Next, a person adds initial lemon juice concentration 29 to the initial concentrate container 31, (herein termed the Method (4)-Step(3) 578). This should be In the preferred embodiment, the volume of the initial lemon juice concentration 29 should be 1 tsp lemon juice or approximately 5 ml. In some embodiments, it is thought that Step 578 may be replaced by a person adds concentrated lemon extract to the initial concentrate container 31 equivalent to 1 tsp lemon juice, herein termed as method (4)-step(6) 581 or perhaps a person adds artificial lemon flavoring to the initial concentrate container 31 equivalent to 1 tsp lemon juice, herein termed as method (4)-step(7) 582.

Next, a person adds an initial champagne concentration 30 to the initial concentrate container 31, (herein termed the Method (4)-Step(4) 579). In this embodiment, the volume of the initial champagne concentration 30 should be ¼ cup or approximately 60 ml. If Step 579 is not included, one can contemplate that a person may add another solute in order to dissolve the initial concentrate ingredients 2. The Step 579 includes sub-component, the initial champagne concentration 30, which helps to perform the step.

And finally, a person mixes the initial concentrate ingredients 2 by mixing the initial concentrate container 31, (herein termed the Method (4)-Step(5) 580). This creates a paste that is subsequently added to the final container. In some alternative embodiments, it is reasonable to contemplate that if Step 580 is not required than over sufficient time then the initial concentrate ingredients 2 may dissolve without mixing. The aforementioned method is herein termed Method (4) 575.

In addition, the Step 528 has several sub steps for using it which are as follows: first, a person procures a tea base container 33 (herein termed the Method (5)-Step(1) 601. Next, a person adds base tea extract concentration 34 of powdered tea extract 22 to the tea base container 33, (herein termed the Method (5)-Step(2) 602). Then, a person adds water 35 to the base tea extract concentration 34 in the tea base container 33, (herein termed the Method (5)-Step(3) 603). Last, a person mixes the water 35 and the base tea extract concentration 34 until the solution is homogenous, (herein termed the Method (5)-Step(4) 604). The aforementioned method is herein termed Method (5) 600.

Overall the preparation of the initial concentrate ingredients involves creating the concentrate, adding the dilute tea base and subsequently adding the champagne. It is contemplated that the process of adding these ingredients and subsequently shaking the container is in and of itself a novel method for the presentation of the beverage. Therefore the steps of combining these ingredients and then shaking them is also considered part of the invention.

I claim:

1. A method for creating a beverage comprising;
procuring tea extract, champagne, water, sugar and citric acid
mixing said tea extract, said champagne, said water, said sugar and said citric acid into a container
wherein the champagne concentration is diluted by half by said water.

2. The method of claim 1 wherein said champagne is a sweet sec champagne.

3. The method of claim 1 wherein said champagne is a rose champagne.

4. The method of claim 3 wherein said rose champagne is a sweet sec champagne.

5. The method of claim 4 wherein said citric acid is a component of lemon juice.

6. The method of claim 5 wherein said tea extract is concentrated soluble tea.

7. The method of claim 5 wherein said tea extract is either oolong, green or black tea powder mix.

8. The method of claim 5 where said tea extract is iced tea mix.

9. The method of claim 8 wherein said champagne is at a concentration between 50-55% of the initial 100% champagne concentration after dilution with said water.

10. The method of claim 7 wherein said champagne is at a concentration between 55-60% of the initial 100% champagne concentration after dilution with said water.

11. The method of claim 9 wherein said iced tea mix is present at a final concentration between 8-12% of the final beverage volume.

12. The method of claim 10 wherein said tea extract is present at a final concentration between 3-4% of the final beverage volume.

13. The method of claim 11 wherein said citric acid is present at a final concentration between 0.01 to 0.005%.

14. The method of claim 12 wherein said citric acid is present at a final concentration between 0.01 to 0.005%.

15. A method for creating a beverage comprising;
procuring tea extract, champagne, water and sugar
mixing an initial concentrated soluble paste wherein said soluble paste comprises an initial volume of tea extract, an initial volume of champagne, lemon juice and sugar
mixing a dilute tea base that comprises a second volume of tea extract and said water
adding said soluble paste and said tea base to a container
adding a second volume of champagne to a container.

16. The method of claim 15 wherein said initial volume of tea extract is between 1-2% of the total final volume of said beverage.

17. The method of claim 16 wherein said initial volume of champagne is between 1-2% of the total final volume of said beverage.

18. The method of claim 17 wherein said sugar is between 2-4% of the total final volume of said beverage.

19. The method of claim 18 wherein said lemon juice is between 0.1% and 0.15% of the total final volume of said beverage.

20. The method of claim 19 wherein said dilute tea base is between 40-45% of the total final volume of the beverage.
